(19) United States
(12) Patent Application Publication
(10) Pub. No.: US 2019/0009956 A1
(43) Pub. Date: Jan. 10, 2019

(54) VIRTUAL AND AUGMENTED-REALITY CAPABLE GIFT BOX

(71) Applicant: Timothy R. Fitzpatrick, New York, NY (US)

(72) Inventor: Timothy R. Fitzpatrick, New York, NY (US)

(21) Appl. No.: 15/643,233

(22) Filed: Jul. 6, 2017

(51) Int. Cl. B65D 51/24; G06F 3/01; G06T 11/00

(52) U.S. Cl. CPC B65D 51/248; G06T 11/00; G06F 3/01; B65D 51/245

(57) ABSTRACT

Embodiment apparatus and associated methods relate to configuring a container with trigger devices physically detectable by a mobile device configured to deliver to a head mounted display multimedia content segments captured from a simulated medical procedure experience, providing the container with the head mounted display to a physical participant scheduled to physically experience the medical procedure, and automatically providing a virtual experience including the scheduled medical procedure to the physical participant based on adapting the timing, sequence, or participant point of view of the multimedia content segments delivered to the head mounted display in response to triggers detected by the mobile device. In an illustrative example, the medical procedure experience may be surgery. In some examples, the participant may be an acute care surgical patient. The virtual experience may include, for example, arrival, check-in, pre-operative care, or recovery, associated with the surgery. Various examples may advantageously provide improved patient satisfaction.

### TECHNICAL FIELD

Various embodiments relate generally to virtual reality.

### BACKGROUND

Virtual reality is an experience that is not real. An experience that is not completely real may include real and artificial elements. Some virtual reality experiences may take place in artificial environments. A virtual environment may be engineered to provide an experience customized to a particular purpose. For example, some virtual experiences may be designed to train or prepare a user to safely engage with the real experience

Virtual experiences may be created with technology adapted to enable a user to interact with a virtual environment. For example, multimedia, sensor, and computer technology may be employed to allow a user to virtually move around, touch, feel, hear, and see characteristics of an artificial environment. For example, an equipment operator in training may use a virtual reality experience to learn operation of a new machine without endangering a real machine or coworkers. Some virtual reality experiences may require substantial investment in equipment, and may be complicated to configure. In some scenarios, virtual experiences may be limited to physical locations of suitable equipment and trained technical support personnel.

Some virtual experiences may employ a combination of artificial and real elements. In various scenarios, a virtual experience of an artificial environment may include images, audio, or other sensory stimuli emanating from a nearby real environment. In some experiences, virtual environments may enhance or transform physical elements into a virtual representation beneficial to the user. For example, in some environments a doctor performing a real procedure on a physical patient may be provided with a head-mounted display providing a visual heat map of the patient's vital signs overlaid with a view of the patient. Such augmented reality may provide the doctor with improved awareness of the patient's response as the procedure progresses.

### SUMMARY

Embodiment apparatus and associated methods relate to configuring a container with trigger devices physically detectable by a mobile device configured to deliver to a head mounted display multimedia content segments captured from a simulated medical procedure experience, providing the container with the head mounted display to a physical participant scheduled to physically experience the medical procedure, and automatically providing a virtual experience including the scheduled medical procedure to the physical participant based on adapting the timing, sequence, or participant point of view of the multimedia content segments delivered to the head mounted display in response to triggers detected by the mobile device. In an illustrative example, the medical procedure experience may be surgery. In some examples, the participant may be an acute care surgical patient. The virtual experience may include, for example, arrival, check-in, pre-operative care, or recovery, associated with the surgery. Various examples may advantageously provide improved patient satisfaction.

Various embodiments may achieve one or more advantages. For example, some embodiments may improve an acute care surgical patient's satisfaction with the results of their surgical procedure. This facilitation may be a result of providing a patient with an immersive virtual reality experience in their home to psychologically prepare the patient for their surgical visit. Some examples may reduce pre-procedure patient anxiety. Such improved patient anxiety levels may be a result of allowing the patient to virtually interact with the hospital environment and staff before the procedure. Various implementations may reduce the cost of health care. Such cost reduction may result from providing home medical device virtual experiences enabling patient self-care and less involvement with trained medical personnel.

In some embodiments, hospital profitability may be improved. Such profitability improvement may be a result of improving patient satisfaction without increased spending directed to in-patient care. Various embodiments may empower patients to decide on the appropriateness of procedures with their physician. This facilitation may be a result of providing a patient with a virtual experience of a procedure involving specific equipment or facilities. In an illustrative example, some equipment used in imaging procedures may frighten certain patients, however a virtual experience may alleviate the patient's fear, or empower the patient to request an alternative procedure. In some embodiments, the time required to perform procedures may be reduced. Such increased procedure delivery effectiveness may be a result of reducing the time needed to explain procedures to patients that have already experienced the procedure visit virtually.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary collaboration view of an embodiment gift box with trigger devices physically detectable by a mobile device configured to deliver to a head mounted display multimedia content segments captured from a simulated medical procedure experience, providing the gift box with the head mounted display to a physical participant scheduled to physically experience the medical procedure, and automatically providing a virtual experience including the scheduled medical procedure to the physical participant based on adapting the timing, sequence, or participant point of view of the multimedia content segments delivered to the head mounted display in response to triggers detected by the mobile device.

FIGS. 2A-2C depict exemplary views of an embodiment gift box and mobile device configured to detect trigger devices embedded in the gift box.

FIG. 3 depicts a structural view of an exemplary mobile device adapted to deliver to a head mounted display multimedia content segments captured from a simulated medical procedure experience in response to triggers detected by the mobile device.

FIG. 4 depicts an exemplary process flow of an embodiment VPAE (Virtual Procedure Adaptation Engine).

FIG. 5 depicts an exemplary process flow of an embodiment VPDE (Virtual Procedure Delivery Engine).

FIG. 6 depicts illustrative operation scenarios of an embodiment mobile device application user interface.

Like reference symbols in the various drawings indicate like elements.

### DETAILED DESCRIPTION OF ILLUSTRATIVE EMBODIMENTS

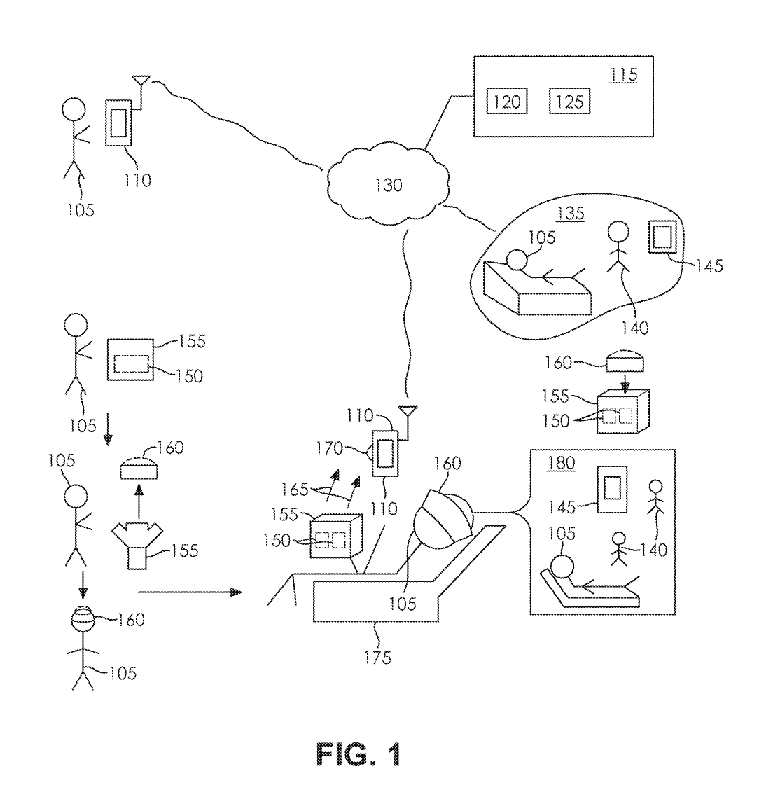

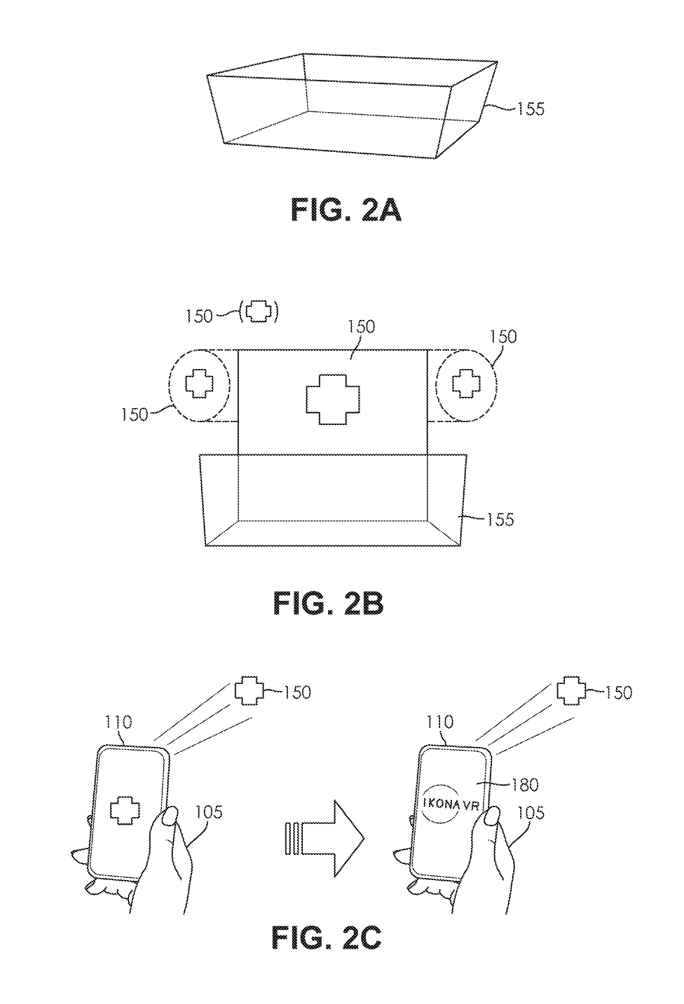

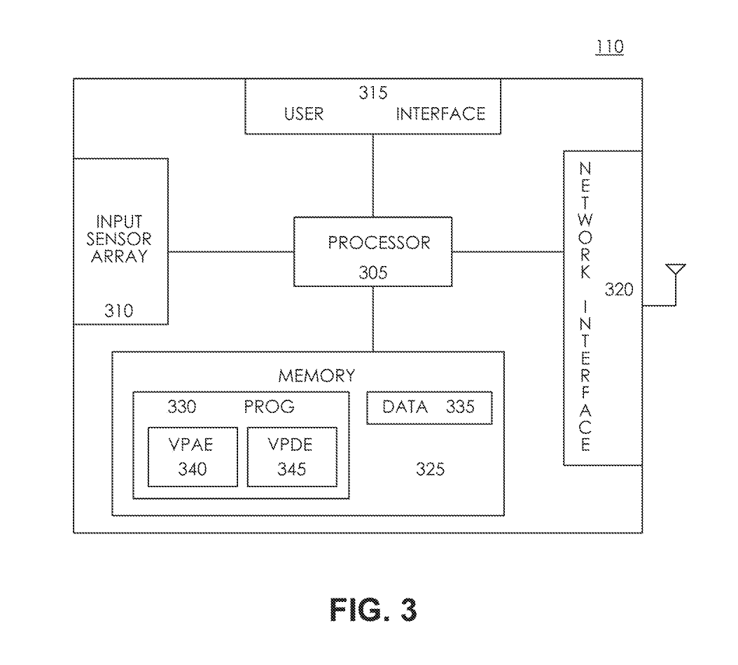

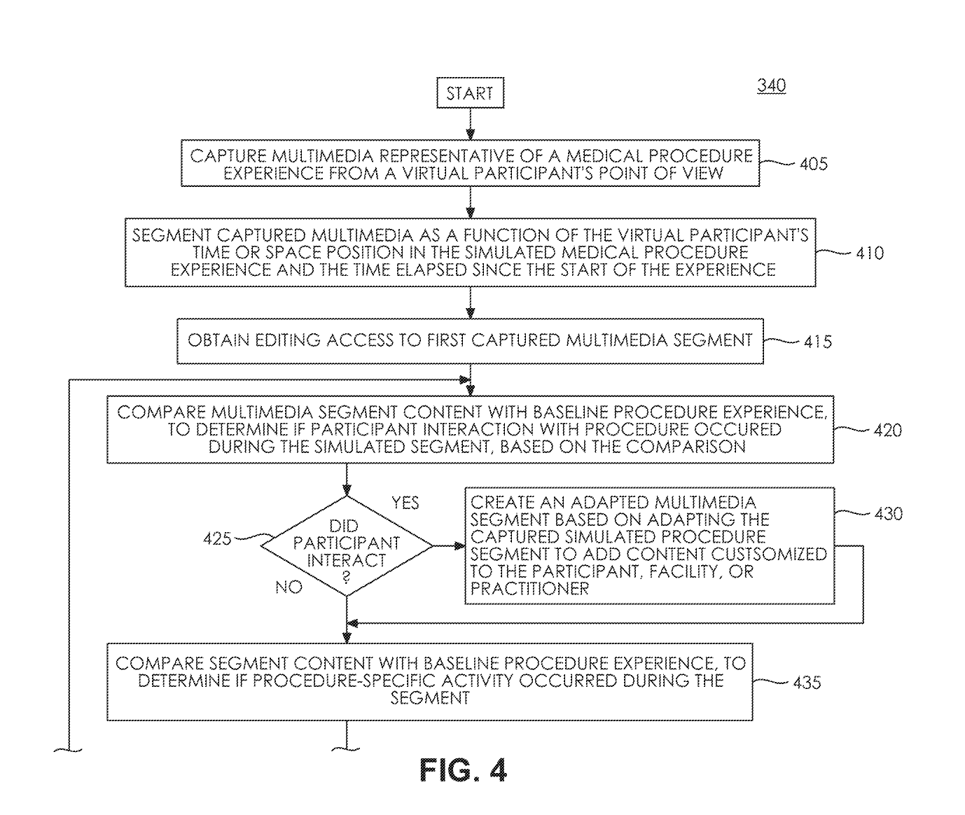

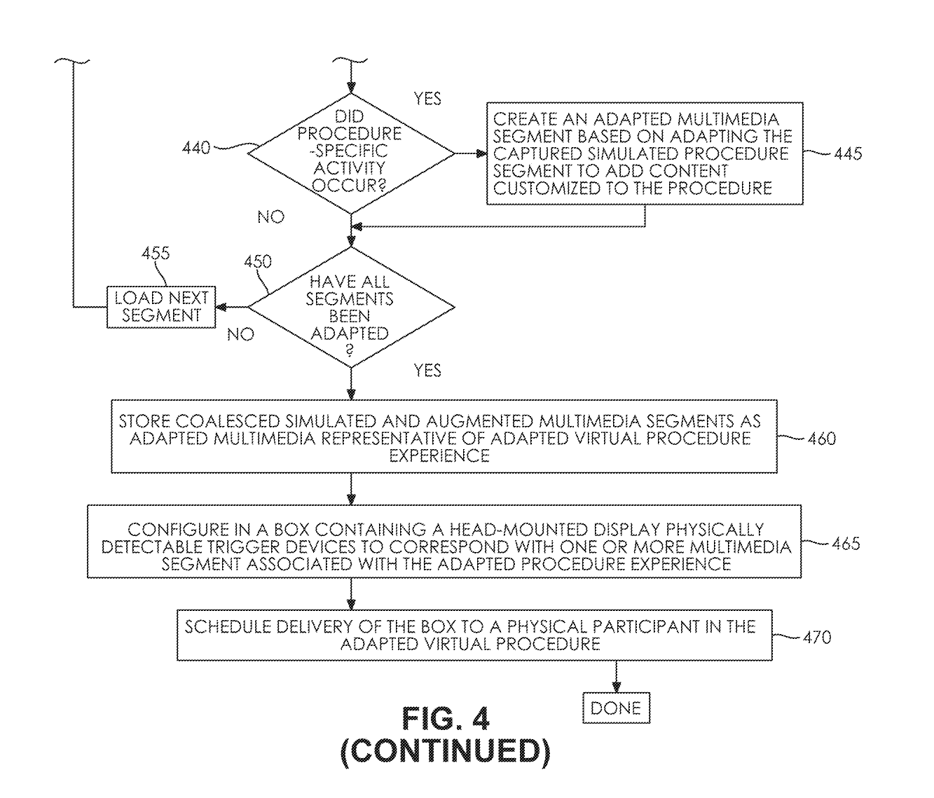

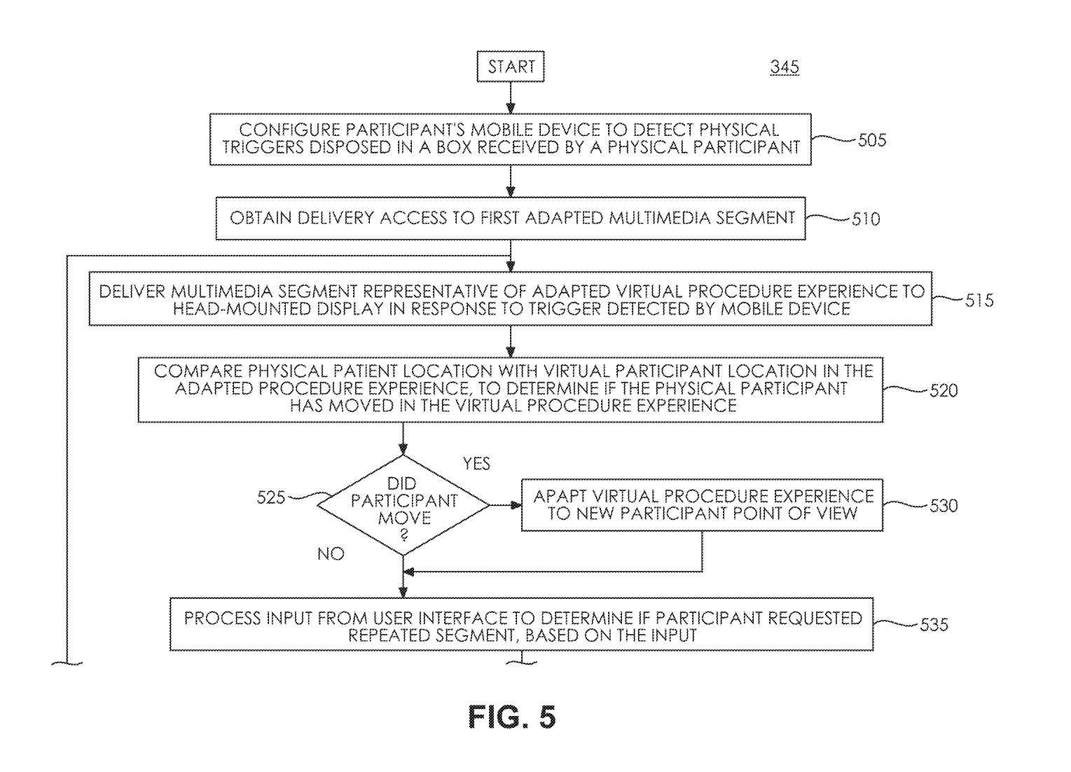

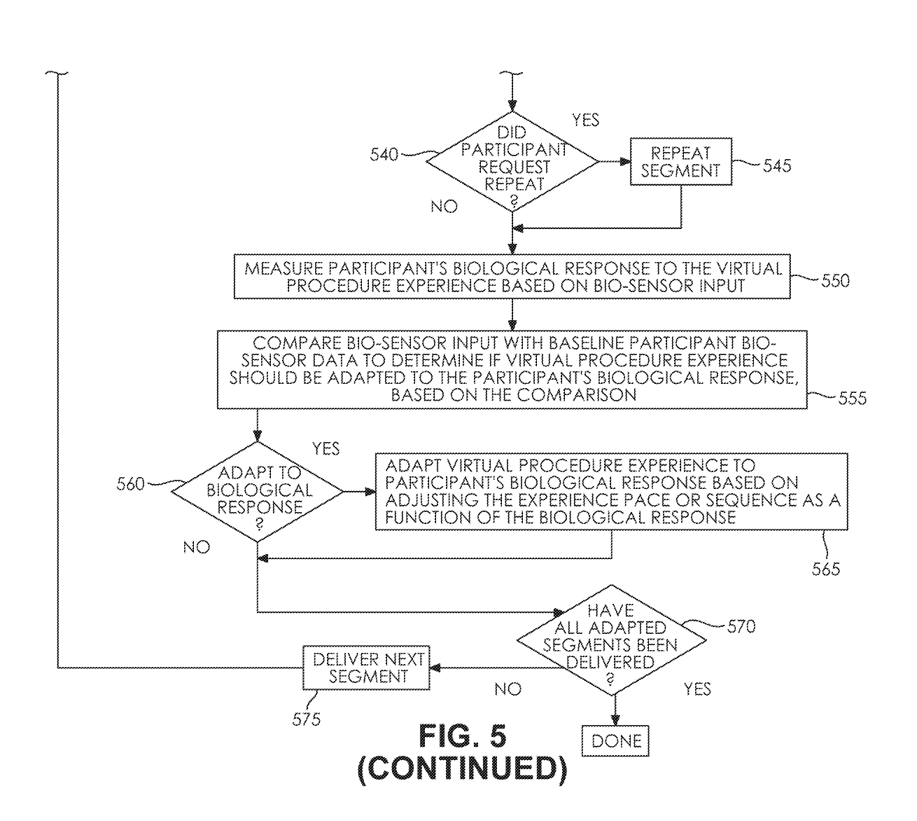

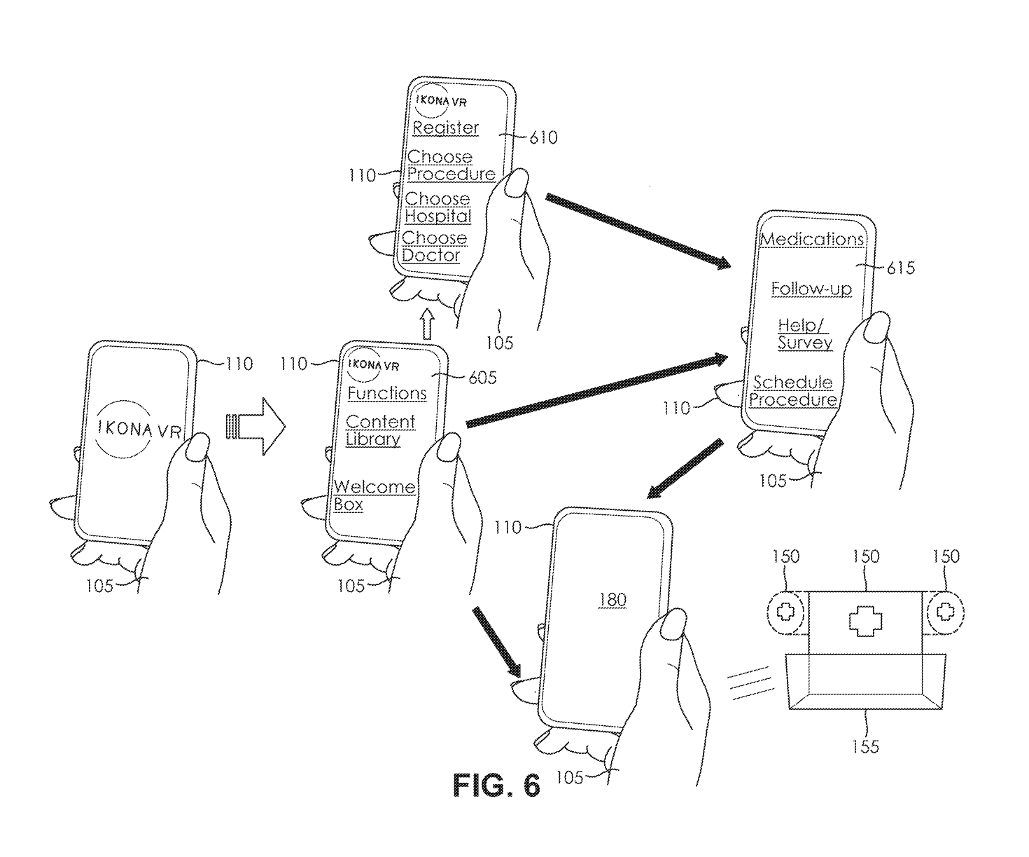

To aid understanding, this document is organized as follows. First, an exemplary design of an embodiment mobile device application and virtual reality-capable gift box collaborating to provide an immersive virtual reality medical procedure experience to an acute care surgical patient is briefly introduced with reference to FIG. 1. Second, with reference to FIGS. 2A-2C, the discussion turns to exemplary embodiments that illustrate the design and construction of an embodiment virtual reality-capable gift box. Specifically, various perspective views of an exemplary virtual reality-capable gift box configured with exemplary physically detectable trigger devices, are presented. Third, with reference to FIG. 3, an illustrative structural view of an exemplary mobile device adapted to deliver to a head mounted display multimedia content segments captured from a simulated medical procedure experience in response to triggers detected by the mobile device, is described. Fourth, with reference to FIG. 4, an illustrative process flow of an exemplary VPAE (Virtual Procedure Adaptation Engine) is presented. Fifth, with reference to FIG. 5, an illustrative process flow of an exemplary VPDE (Virtual Procedure Delivery Engine) is disclosed. Finally, with reference to FIG. 6, illustrative operation scenarios of an embodiment mobile device application user interface are presented.

FIG. 1 depicts an exemplary collaboration view of an embodiment gift box with trigger devices physically detectable by a mobile device configured to deliver to a head mounted display multimedia content segments captured from a simulated medical procedure experience, providing the gift box with the head mounted display to a physical participant scheduled to physically experience the medical procedure, and automatically providing a virtual experience including the scheduled medical procedure to the physical participant based on adapting the timing, sequence, or participant point of view of the multimedia content segments delivered to the head mounted display in response to triggers detected by the mobile device. In FIG. 1, medical procedure patient 105 uses mobile device 110 to schedule a medical procedure with cloud server 115 hosting scheduling service 120 and medical procedure database 125 via network cloud 130. In the depicted embodiment, a simulated medical procedure 135 is staged to capture multimedia content representative of the scheduled procedure, with doctor 140 using medical procedure equipment 145 simulating treatment of the patient 105 in the staged procedure. In an illustrative example, multimedia content descriptive of the simulated medical procedure 135 may be captured from multiple spatially separated cameras and microphones. In the depicted example, the multimedia content captured from the simulated medical procedure 135 is stored in medical procedure database 125. In the illustrated embodiment, physically detectable trigger devices 150 are embedded in box 155 and configured to trigger mobile device 110 to deliver a virtual reality experience derived from the captured multimedia content to the head mounted display 160 introduced into the box 155. In the illustrated example, the triggers 150 and head mounted display 160 are delivered with the box 155 to the patient 105. In the depicted embodiment, the patient 105 removes the head mounted display 160 from the box 150. In an illustrative example, the patient 105 secures the head mounted display 160 on their head and activates mobile device 110 to physically detect 165 triggers 150 with detector 170. In the illustrated example, the patient 105 activates the mobile device 110 at a location 175 remote from the location of the simulated procedure 135, to participate in an immersive virtual procedure experience 180 delivered to the head mounted display 160 by the mobile device 110 in response to triggers detected by the mobile device 110. In the depicted example, the virtual procedure experience 180 includes multimedia content captured from the simulated procedure 135. In the illustrated embodiment, the virtual procedure experience 180 also includes multimedia content customized based on the doctor, the procedure, and hospital associated with the scheduled procedure. For example, the multimedia content delivered to the head mounted display 160 by the mobile device 110 may include multimedia segments captured from a patient point of view and depicting the specific doctor 140 or medical equipment 145 the patient will encounter at the scheduled procedure. In some examples, the virtual procedure experience 180 may also include multimedia content delivered to the head mounted display adapted in timing, sequence, or participant point of view in response to triggers detected by the mobile device 110. In various implementations, multimedia content delivered to the head mounted display may be delayed, or presented early, relative to baseline presentation timing determined as a function of the multimedia format and participant interaction within the virtual environment. In an illustrative example, multimedia content delivered to the head mounted display may be presented in a different order, relative to baseline presentation ordering determined as a function of the multimedia format and participant interaction within the virtual environment. In some examples, multimedia content delivered to the head mounted display may be composed of more than one multimedia source mixed as a function of the participant point of view within the virtual environment. In some designs, the multimedia content mixture may be determined based on combining more than one camera video stream mixed as a function of the location of the participant within the virtual environment. For example, the patient 105 may point the trigger detector 170 configured in mobile device 110 in the direction of one or more trigger 150. In various examples, one or more trigger 150 may visually represent to the patient 105 a phase of the scheduled procedure experience. In an illustrative example, one or more trigger 150 may be configured to visually display on the box 155 a portion of the scheduled procedure. For example, the box 155 may depict a map of a hospital, including parking areas, entrances, hallways, procedure rooms, and recovery rooms, with each area on the map corresponding to a specific trigger 150 configured to cause the mobile device 110 to deliver to the head mounted display 160 multimedia content specific to the corresponding map area. In an illustrative example, one or more trigger 150 may represent a phase of a procedure. For example, a trigger 150 may be configured to correspond with patient arrival to a hospital, triggering the mobile device 110 to deliver to the head mounted display 160 multimedia content specific to patient ingress to the hospital, including such experiences as parking, check-in, or insurance processing. In some examples, a trigger 150 may be configured to correspond with patient perioperative experience, including such aspects as interacting with an approaching doctor or nurse, or regaining consciousness in a recovery room.

FIGS. 2A-2C depict exemplary views of an embodiment gift box and mobile device configured to detect trigger devices embedded in the gift box. In FIG. 2A, the depicted box 155 has been formed from a planar structure formed in sections divided along creases disposed in the planar structure at substantially right angles to adjacent creases. In an illustrative example, the box 155 may be composed from cardboard. In some embodiments, the box 155 may be open at one end. In various implementations, the box 155 may be formed from material suitable for use as a container to retain a delicate instrument during shipping. For example, the box may be formed from cardboard having sufficient strength to withstand crushing when stacked with up to four similar boxes weighing up to fifty pounds each. In various examples, the box exterior may be decorated with branding, logos, maps, or messages suitable to a recipient of the box 155. In some embodiments, the recipient of the box 155 may be a surgical patient scheduled to experience a medical procedure in a hospital. In various examples, the recipient of the box 155 may be a prospective real estate buyer. In an illustrative example, the recipient of the box 155 may be a prospective guest at a hotel or resort. In some examples, the recipient of the box 155 may be a prospective student of a school or university In FIG. 2B, one or more physically detectable trigger device 150 is embedded in the box 155. In an illustrative example, the one or more physically detectable trigger device 150 may be adapted to be detected by mobile device 110. In some embodiments, physically detectable trigger device 150 may be an image. In some designs, physically detectable trigger device 150 may be an image encoding data. In various examples, physically detectable trigger device 150 may be a sticker. In some designs, physically detectable trigger device 150 may be light reflector. In various implementations, physically detectable trigger device 150 may be an audio emitter. In some examples, physically detectable trigger device 150 may be an emitter of radio-frequency energy. In FIG. 2B, the box 155 is depicted substantially formed with one partially open side. In the depicted embodiment, triggers 150 are illustrated in exemplary configurations and disposed substantially conformant with the planar structure forming a portion of the box interior. In the illustrated embodiment, the physically detectable triggers 150 are retained in tabs protruding from a partially open side of the box 155. In FIG. 2C, the virtual procedure experience 180 presented via the mobile device 110 to the patient 105 includes multimedia content triggered in response to the mobile device 110 detection of one or more trigger device 150.

FIG. 3 depicts a structural view of an exemplary mobile device adapted to deliver to a head mounted display multimedia content segments captured from a simulated medical procedure experience in response to triggers detected by the mobile device. In FIG. 3, a block diagram of an exemplary mobile device 110 includes processor 305, input sensor array 310, user interface 315, network interface 320, and memory 325. The processor 305 is in electrical communication with the memory 325. The depicted memory 325 includes program memory 330 and data memory 335. The program memory 330 includes processor-executable program instructions implementing VPAE (Virtual Procedure Adaptation Engine) 340, and VPDE (Virtual Procedure Delivery Engine) 345. In the depicted embodiment, the processor 305 is communicatively and operably coupled with the input sensor array 310, user interface 315, and network interface 320. In an illustrative example, the sensor array 310 may be referred to as a sensor module. In various implementations, the network interface 320 may be a wireless network interface. In some designs, the network interface 320 may be a Wi-Fi interface. In some embodiments, the network interface 320 may be a Bluetooth interface. In an illustrative example, the mobile device 110 may include more than one network interface 320. In some designs, the network interface 320 may be a wireline interface. In some designs, the network interface 320 may be omitted. In various implementations, the user interface 315 may be adapted to receive input from a user or send output to a user. In some embodiments, the user interface 315 may be adapted to an input-only or output-only user interface mode. In various implementations, the user interface 315 may be an imaging display. In some implementations, the user interface 315 may be touch-sensitive. In some designs, the mobile device 110 may include an accelerometer operably coupled with the processor 305. In various embodiments, the mobile device 110 may include a GPS module operably coupled with the processor 305. In an illustrative example, the mobile device 110 may include a magnetometer operably coupled with the processor 305. In some embodiments, the input sensor array 310 may include one or more imaging sensor. In various designs, the input sensor array 310 may include one or more audio transducer. In some implementations, the input sensor array 310 may include a radio-frequency detector. In an illustrative example, the input sensor array 310 may include an ultrasonic audio transducer. In some embodiments, the input sensor array 310 may include image sensing subsystems or modules configurable by the processor 305 to be adapted to provide image input capability, image output capability, image sampling, spectral image analysis, correlation, autocorrelation, Fourier transforms, image buffering, image filtering operations including adjusting frequency response and attenuation characteristics of spatial domain and frequency domain filters, image recognition, pattern recognition, or anomaly detection. In various implementations, the depicted memory 325 may contain processor executable program instruction modules configurable by the processor 305 to be adapted to provide image input capability, image output capability, image sampling, spectral image analysis, correlation, autocorrelation, Fourier transforms, image buffering, image filtering operations including adjusting frequency response and attenuation characteristics of spatial domain and frequency domain filters, image recognition, pattern recognition, or anomaly detection.

FIG. 4 depicts an exemplary process flow of an embodiment VPAE (Virtual Procedure Adaptation Engine). In FIG. 4, an embodiment VPAE 340 process flow is depicted automatically adapting the timing, sequence, or participant point of view of captured multimedia content segments based on customizing the multimedia content to the patient, procedure, or facility. The process depicted in FIG. 4 is given from the perspective of the VPAE 340 executing as program instructions on processor 305 of mobile device 110, depicted in FIG. 3. In some embodiments, the VPAE 340 may execute as a cloud service on cloud server 115 governed by the processor 305 via network cloud 130, depicted in FIG. 1. The depicted process begins at step 405 with the processor 305 capturing multimedia representative of a medical procedure experience from a virtual participant's point of view. The process continues at step 410 with the processor 305 segmenting captured multimedia as a function of the virtual participant's time or space position in the simulated medical procedure experience and the time elapsed since the start of the experience. The process continues at step 415 with the processor 305 obtaining editing access to the first captured multimedia segment. In some embodiments, the processor 305 may obtain editing access to a multimedia segment based on opening the multimedia segment for write operation in a file system operation. In various implementations, the processor 305 may obtain editing access to a multimedia segment based on accessing a buffer with write permission in the data memory 335, depicted in FIG. 3. The process continues at step 420 with the processor 305 comparing the multimedia segment content with the baseline procedure experience, to determine if participant interaction with procedure occurred during the simulated segment, based on the comparison. At step 425, upon a determination by the processor 305 that the participant interacted with the procedure, the process continues at step 430 with the processor 305 creating an adapted multimedia segment based on adapting the captured simulated procedure segment to add content customized to the participant, facility, or practitioner. At step 425, upon a determination by the processor 305 that the participant did not interact with the procedure, the process continues at step 435 with the processor 305 comparing segment content with the baseline procedure experience, to determine if procedure-specific activity occurred during the segment. At step 440, upon a determination by the processor 305 that procedure-specific activity occurred during the segment, the process continues at step 445 with the processor 305 creating an adapted multimedia segment based on adapting the captured simulated procedure segment to add content customized to the procedure. Upon a determination by the processor 305 at step 440 that procedure-specific activity did not occur during the segment, the process continues at step 450 with the processor 305 determining if all captured multimedia segments have been adapted. Upon a determination by the processor at step 450 that all segments have not been adapted, the processor 305 at step 455 loads the next segment, and the process continues at step 420 with the processor 305 comparing the multimedia segment content with the baseline procedure experience, to determine if participant interaction with procedure occurred during the simulated segment, based on the comparison. Upon a determination by the processor at step 450 that all segments have been adapted, the process continues at step 460 with the processor 305 storing coalesced simulated and augmented multimedia segments as adapted multimedia representative of adapted virtual procedure experience. The process continues at step 465 with the processor 305 configuring in a box 155 containing a head-mounted display 160 physically detectable trigger devices 150 to correspond with one or more multimedia segment associated with the adapted procedure experience. The process continues at step 470 with the processor 305 scheduling delivery of the box 155 to a physical participant in the adapted virtual procedure, and the process ends.

FIG. 5 depicts an exemplary process flow of an embodiment VPDE (Virtual Procedure Delivery Engine). In FIG. 5, an embodiment VPDE 345 process flow is depicted automatically adapting the timing, sequence, or participant point of view of captured multimedia content for delivery to a head mounted display in response to triggers physically detected by a mobile device. The process depicted in FIG. 5 is given from the perspective of the VPDE 345 executing as program instructions on processor 305 of mobile device 110, depicted in FIG. 3. In some embodiments, the VPDE 345 may execute as a cloud service on cloud server 115 governed by the processor 305 via network cloud 130, depicted in FIG. 1. The depicted process begins at step 505 with the processor 305 configuring the participant's mobile device 110 to detect physical triggers 150 embedded in a box 155 received by a physical participant. The process continues at step 510 with the processor 305 obtaining delivery access to the first adapted multimedia segment. In an illustrative example, the processor 305 may obtain delivery access to an adapted multimedia segment to store the multimedia segment in a communication buffer for delivery to the head mounted display 160. In some embodiments, the processor 305 may obtain delivery access to an adapted multimedia segment based on opening the multimedia segment with read permission in a file system operation. In some designs, the processor 305 may obtain delivery access to a multimedia segment based on accessing a buffer with read permission in the data memory 335, depicted in FIG. 3. The process continues at step 515 with the processor 305 delivering a multimedia segment representative of an adapted virtual procedure experience to a head-mounted display in response to a trigger detected by mobile device 110. The process continues at step 520 with the processor 305 comparing physical patient location with virtual participant location in the adapted procedure experience, to determine if the physical participant has moved in the virtual procedure experience, based on the comparison. The process continues at step 525 with the processor 305 determining if the physical participant moved, based on the comparison by the processor 305 at step 520. Upon a determination by the processor 305 the physical participant moved, the process continues at step 530 with the processor 305 adapting the virtual procedure experience to the new participant point of view derived by the processor 305 based on the movement of the physical participant determined by the processor 305 at step 520. Upon a determination by the processor 305 the physical participant did not move, the process continues at step 535 with the processor 305 processing input from user interface to determine if the participant requested a repeated segment, based on the input. The process continues at step 540 with the processor 305 determining if the participant requested a repeated segment, based on the input processed by the processor at step 535. Upon a determination by the processor 305 the participant requested a repeated segment, the process continues at step 545 with the processor repeating the segment. Upon a determination by the processor 305 the participant did not request a repeated segment, the process continues at step 550 with the processor 305 measuring the participant's biological response to the virtual procedure experience based on bio-sensor input received by mobile device 110. In some examples, the participant's biological response may include physiological measurements including heart rate, blood pressure, respiration rate, pupil (eye) dilation, skin electrical resistance, or body temperature. In some examples, measurement of the participant's biological response may be accomplished by sensors configured in the mobile device 110. In various designs, the participant's pupil (eye) dilation may be measured with optical sensors configured in the head mounted display 160. In some designs, data from sensors configured in the head mounted display may be transmitted to the processor 305 via one or more wireless communication link. The process continues at step 555 with the processor 305 comparing the bio-sensor input with baseline participant bio-sensor data to determine if the virtual procedure experience should be adapted to the participant's biological response, based on the comparison. The process continues at step 560 with the processor 305 determining if the virtual procedure experience should be adapted to the participant's biological response, based on the comparison by the processor at step 555. Upon a determination by the processor 305 at step 560 that the virtual procedure experience should be adapted to the participant's biological response, the process continues at step 565 with the processor 305 adapting the virtual procedure experience to participant's biological response based on adjusting the experience pace or sequence as a function of the biological response. Upon a determination by the processor 305 at step 560 the virtual procedure experience should not be adapted to the participant's biological response, the process continues at step 570 with the processor 305 determining if all adapted segments have been delivered. Upon a determination by the processor 305 at step 570 that all adapted segments have not been delivered, the process continues at step 515 with the processor 305 delivering a multimedia segment representative of an adapted virtual procedure experience to a head-mounted display in response to a trigger detected by mobile device 110. Upon a determination by the processor 305 at step 570 that all adapted segments have been delivered, the process ends.

FIG. 6 depicts illustrative operation scenarios of an embodiment mobile device application user interface. In FIG. 6, patient 105 accesses virtual procedure experience 180 via exemplary mobile device 110 application user interface. In the depicted embodiment, the virtual procedure experience 180 presented via the mobile device 110 to the patient 105 includes multimedia content triggered in response to the mobile device 110 detection of one or more trigger device 150 in box 155. In the illustrated example, the patient 105 downloads the mobile application to the mobile device 110. In the depicted embodiment, the patient 105 opens the mobile application and the patient 105 may select various operational modes from the main menu 605 of the mobile application. For example, the patient 105 may select the Welcome Box option from the main menu 605 to engage a Welcome Box Experience. In the illustrated example, the Welcome Box Experience is virtual procedure experience 180 presented via the mobile device 110 to the patient 105. In some embodiments, the Welcome Box Experience may include multimedia content triggered in response to the mobile device 110 detection of one or more trigger device 150 embedded in the box 155. In an illustrative scenario of mobile application usage, the patient 105 may select the Content Library option from the main menu 605 to browse a Virtual Reality Content Library. In some embodiments, the Virtual Reality Content Library may include multimedia content segments enabling various Virtual Reality experiences selectable by the patient 105. In some examples, the Virtual Reality experiences enabled by the Virtual Reality Content Library may include hospital visits, medical procedures, peri-operative experiences, and interaction with health care professionals. Any portion of a patient's medical treatment may be available in the Virtual Reality Content Library. In some examples, the patient 105 may select the Functions option from the main menu 605 to engage further features including configuration, customization, and selection of a Virtual Reality experience for the patient 105. In the illustrated example, upon selecting the Functions option from the main menu 605, the patient 105 is presented with various choices in exemplary Functions menu 610. For example, the patient 105 may select Choose Procedure to browse and select from procedures available in the Virtual Reality Content Library. In the depicted embodiment, the patient 105 may select Choose Hospital to browse and select from hospitals available in the Virtual Reality Content Library. In the illustrated example, the patient 105 may select Choose Doctor to browse and select from doctors available in the Virtual Reality Content library. In some embodiments, the Virtual Reality Content Library may contain multimedia content segments representative of procedures, hospitals, and doctors. In various implementations, the multimedia content segments stored in the Virtual Reality Content Library, and representative of procedures, hospitals, and doctors, may be merged into virtual procedure experience 180 and presented via the mobile device 110 to the patient 105. In some embodiments, the virtual procedure experience 180 may be delivered by the mobile device 110 to head-mounted display 160, depicted in FIG. 1, for presentation to the patient 105. In the depicted embodiment, the patient 105 may choose Register from exemplary Functions menu 610, to configure care options for patient 105 as presented in exemplary care options menu 615. In the illustrated example, the patient 105 may select Medications from the care options menu 615 to enter and receive information on patient 105 medications. In the depicted example, the medication information entered by patient 105 may include dose levels and dosing schedules for medications the patient may be taking prior to surgery. In the illustrated embodiment, the medication information presented to the patient may include instructions on how or when medication should be taken, scheduling reminders for dosing, an option to integrate medication dosing schedule reminders with calendar applications or services employed by the patient or caregiver, and pharmacy contact information for medication-related questions or concerns. In the depicted embodiment, the patient 105 may select Follow-up from the care options menu 615. In the depicted example, the Follow-up menu option may present the patient 105 with a Virtual Discharge Summary. In the illustrated example, the Virtual Discharge Summary may include a listing of medical providers or medical personnel the patient should contact for follow-up care or consultation after physical discharge. In some embodiments, the Virtual Discharge Summary may include contact information of the medical provider or medical personnel the patient should follow up with after discharge. In the illustrated example, the Virtual Discharge Summary includes a Help/Survey option to provide the patient with answers to frequently asked questions, and enable the patient to report their level of satisfaction concerning their Virtual Procedure. In some embodiments, the Help/Survey option may provide the patient 105 with access to a database of answers to questions concerning their outpatient experience. In various implementations, the patient 105 may label database questions with the specific hospital, procedure, or doctor providing their procedure. In some embodiments, Supervised or Unsupervised machine learning algorithms may be employed to detect anomalies in frequently occurring questions or labels in the database. For example, Supervised or Unsupervised Machine Learning may detect anomalies in frequently occurring questions related to specific hospitals, procedures, or physicians. In some embodiments, real-time feedback on patient satisfaction may be determined as a function of the patient input to the Help/Survey menu. In some examples, quality improvement initiatives may be implemented by hospitals or Virtual Procedure Providers in response to statistical analysis or predictive analysis of the Help/Survey data. In an illustrative example, a Virtual Procedure Provider may be an entity providing Virtual Reality medical procedure experiences. In some examples, the Help/Survey menu may automate a post-discharge survey to patients to measure patient satisfaction with their procedure. In an illustrative example, the post-discharge survey may measure patient satisfaction with the doctor. In some examples, the post-discharge survey may measure patient comfort. In various implementations, the post-discharge survey may measure the patient's assessment of how well the virtual procedure experience 180 prepared the patient 105 for the physical procedure. In the depicted embodiment, the patient 105 may select the Schedule Procedure option from the exemplary care options menu 615. In the illustrated example, selection of the Schedule Procedure option may present the patient 105 with choices of procedures, doctors, and hospitals from which to schedule a physical medical procedure. In some embodiments, the hospital or doctor scheduled to perform the physical procedure may be provided with patient 105 experience data representative of the patient 105 usage of virtual procedure experience 180 delivered by the mobile device 110. In some embodiments, the experience data representative of the patient 105 usage of virtual procedure experience 180 may include an indication of time spent in various phases of the virtual procedure experience 180. In various implementations, the experience data representative of the patient 105 usage of virtual procedure experience 180 may include the patient's biological response. In an illustrative example, the patient's biological response may include such measured parameters as heart rate, blood pressure, respiration rate, or neuro-physical signals such as brain waves. For example, a hospital or doctor may use such patient experience data to adapt phases or portions of the physical procedure as a function of the patient's response to the virtual procedure experience 180.

Although various embodiments have been described with reference to the Figures, other embodiments are possible. For example, although adaptation and delivery of virtual medical procedures have been presented as illustrative examples of various embodiments, adaptation and delivery of other virtual experiences are intended to fall within the scope of the disclosure. In an illustrative example, with reference to FIG. 1, in some embodiments, the patient 105 may be a participant in a training exercise, the doctor 140 may be an instructor, the medical equipment 145 may be equipment the participant 105 is training to use, and the virtual procedure experience 180 may be a virtual training experience. In an illustrative example, with reference to FIG. 1, in some embodiments, the patient 105 may be a real estate client browsing homes for sale, the doctor 140 may be a real estate agent, and the virtual procedure experience 180 may be a virtual real estate showing of a home for sale. In an illustrative example, with reference to FIG. 1, in some embodiments, the patient 105 may be a prospective hotel or resort guest, the doctor 140 may be a hospitality specialist, and the virtual procedure experience 180 may be a virtual hotel or resort tour experience.

Various embodiments may include personalized gift boxes delivered to patients' homes upon their request. In some examples, the package may include a virtual reality-capable Head Mounted Display (HMD) based on a patient's smartphone type, instructions for using the HMD, a hospitality-centered gift such as cashmere socks, and required paperwork from the hospital or medical center where the patient will be receiving their upcoming care. In some embodiments, the purpose of the box may be to provide a unique pre-procedure experience, which prepares patients for their upcoming hospitalizations by immersing them in the specific hospital environment where they will receive their care. In various implementations, an objective of delivering such a pre-procedural experience to patients' homes may be to add to their level of comfort, which ultimately reduces anxiety prior to an operation and improves the outcomes of their respective hospitalizations.

In some exemplary scenarios of use, such a Virtual Reality technology may be implemented centrally in hospitals and medical centers. In some prior art scenarios, such an approach required patients to travel to the facilities, where they were given the opportunity to experience content with a Virtual Reality HMD.

In such prior art scenarios, some disadvantages may be associated with work flow implementation, which may vary per hospital and is therefore complex and has some friction. For example, such a prior art implementation may require hospital personnel or personnel associated with a Virtual Procedure Provider to be present in order to field questions and ensure the patient can operate the headset (HMD) properly. In some examples, the box implementation of providing Virtual Procedures may overcome patient technical challenges by providing a mobile device application configured to provide adaptive and interactive instructions to the patient.

In some embodiments, the box itself may contain trigger devices, including images, text, or stickers that trigger Augmented and Virtual Reality experiences in an embodiment mobile application. In some designs, each tab of the open box may have a unique experience based on the trigger devices that correspond to images/experiences on an embodiment mobile application. In various implementations, the exterior of an embodiment box may be branded with a Virtual Procedure Provider logo. In some designs, the interior of an embodiment box may be branded with the hospital/medical center's logos where the patients will be receiving their care.

In an illustrative example, an approach such as sending a box to patient's homes, in conjunction with embodiment video and mobile application content, which may be enabled and experienced through the box may allow patients to experience their upcoming hospitalizations in a way that has never been possible before. In various embodiments, Virtual and Augmented Reality may change the way patients experience their care, while also improving outcomes of those hospitalizations through the better preparation.

In various designs, virtual experience content may be added via an embodiment connected mobile application, for patients to choose from during the perioperative period. In some examples, medical devices may be added to an embodiment connected mobile application for patients opting to try new devices at home. In various implementations, such provision of home medical device virtual experiences may enable device companies to reach patients and to effectively show them, through Virtual and Augmented Reality, how to apply/use their devices without the need for medical supervision.

In an illustrative example, insurers may want to use embodiment connected mobile applications to deliver home care for patients in using their coverage, helping to connect their customers with partners in their networks. In some examples, medical device companies and pharmaceutical companies may use embodiment connected mobile applications to reach patients and teach them how to reliably self-administer their drugs and devices without the need for hospital supervision.

In an illustrative example according to an embodiment of the present invention, the system and method are accomplished through the use of one or more computing devices. As depicted in FIG. 1 and FIG. 3, one of ordinary skill in the art would appreciate that an exemplary mobile device 110 appropriate for use with embodiments of the present application may generally be comprised of one or more of a Central processing Unit (CPU), Random Access Memory (RAM), a storage medium (e.g., hard disk drive, solid state drive, flash memory, cloud storage), an operating system (OS), one or more application software, a display element, one or more communications means, or one or more input/output devices/means. Examples of computing devices usable with embodiments of the present invention include, but are not limited to, proprietary computing devices, personal computers, mobile computing devices, tablet PCs, mini-PCs, servers or any combination thereof. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In various embodiments, communications means, data store(s), processor(s), or memory may interact with other components on the computing device, in order to effect the provisioning and display of various functionalities associated with the system and method detailed herein. One of ordinary skill in the art would appreciate that there are numerous configurations that could be utilized with embodiments of the present invention, and embodiments of the present invention are contemplated for use with any appropriate configuration.

According to an embodiment of the present invention, the communications means of the system may be, for instance, any means for communicating data over one or more networks or to one or more peripheral devices attached to the system. Appropriate communications means may include, but are not limited to, circuitry and control systems for providing wireless connections, wired connections, cellular connections, data port connections, Bluetooth connections, or any combination thereof. One of ordinary skill in the art would appreciate that there are numerous communications means that may be utilized with embodiments of the present invention, and embodiments of the present invention are contemplated for use with any communications means.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

Many suitable methods and corresponding materials to make each of the individual parts of embodiment apparatus are known in the art. According to an embodiment of the present invention, one or more of the parts may be formed by machining, 3D printing (also known as “additive” manufacturing), CNC machined parts (also known as “subtractive” manufacturing), and injection molding, as will be apparent to a person of ordinary skill in the art. Metals, wood, thermoplastic and thermosetting polymers, resins and elastomers as described herein-above may be used. Many suitable materials are known and available and can be selected and mixed depending on desired strength and flexibility, preferred manufacturing method and particular use, as will be apparent to a person of ordinary skill in the art.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. An apparatus, comprising a box adapted to trigger a mobile device to deliver a virtual reality experience, comprising:
a box, comprising a planar structure formed in sections divided along creases disposed in the planar structure at substantially right angles to adjacent creases; and,
a trigger device, physically detectable by a mobile device, and disposed substantially conformant with a plane of the planar structure.

2. The apparatus of claim 1, wherein the trigger device further comprises an image.

3. The apparatus of claim 2, wherein the image further comprises encoded data.

4. The apparatus of claim 1, wherein the trigger device further comprises text.

5. The apparatus of claim 1, wherein the trigger device further comprises an audio emitter.

6. The apparatus of claim 1, wherein the trigger device further comprises an emitter of radio-frequency energy.

7. The apparatus of claim 1, wherein the trigger device further comprises a removable sticker.

8. The apparatus of claim 1, wherein the box further comprises at least one tab displaying a visual representation of a portion of a virtual reality experience.

9. The apparatus of claim 1, wherein the box further comprises an exterior marking identifying a Virtual Procedure Provider.

10. The apparatus of claim 1, wherein the box further comprises an interior marking identifying a hospital.

11. A process to adapt a simulated experience to a participant scheduled to receive a physical experience, comprising:
configuring a container with trigger devices physically detectable by a mobile device configured to deliver to a head mounted display multimedia content segments captured from the simulated experience;
scheduling delivery of the container with the head mounted display to a physical participant scheduled for the physical experience; and,
automatically providing a virtual experience including the simulated experience to the physical participant based on adapting the timing, sequence, or participant point of view of the multimedia content segments delivered to the head mounted display in response to triggers detected by the mobile device.

12. The process of claim 11, wherein the participant is an acute care surgical patient.

13. The process of claim 12, wherein the virtual experience further comprises multimedia content segments representative of the patient's perioperative experience.

14. The process of claim 12, wherein the virtual experience further comprises multimedia content segments representative of the patient's arrival to or departure from a hospital.

15. The process of claim 11, wherein the participant is a prospective guest at a hotel, and the virtual experience further comprises multimedia content segments representative of the hotel.

16. The process of claim 11, wherein the participant is a health care worker trainee learning to provide a medical procedure, and the virtual experience further comprises multimedia content segments representative of the medical procedure.

17. A process to deliver a virtual experience including a simulated experience to a physical participant, comprising:
configuring a box with physically detectable devices adapted to trigger a mobile device to deliver a virtual reality experience;
configuring a mobile device to adapt the timing, sequence, or participant point of view of the multimedia content segments delivered to a head mounted display in response to triggers detected by the mobile device, the mobile device comprising:
a processor;
a sensor module adapted to physically detect a trigger device, the sensor module operably and communicatively coupled with the processor; and,
a memory that is not a transitory propagating signal, the memory connected to the processor and encoding computer readable instructions, including processor executable program instructions, the computer readable instructions accessible to the processor, wherein the processor executable program instructions, when executed by the processor, cause the processor to perform operations comprising:
detecting a trigger device;
adapting the timing, sequence, or participant point of view of the multimedia content segments as a function of the detected trigger device; and,
delivering the adapted multimedia content segments to a head mounted display.

18. The process of claim 17, wherein the participant is an acute care surgical patient.

19. The process of claim 18, wherein the operations performed by the processor further comprise delivering multimedia content segments representative of the patient's perioperative experience.

20. The process of claim 17, wherein the operations performed by the processor further comprise adapting the timing, sequence, or participant point of view of the multimedia content segments as a function of participant biological response detected by the sensor module.
